(19) United States
(12) Patent Application Publication
(10) Pub. No.: US 2013/0086972 A1
(43) Pub. Date: Apr. 11, 2013

(54) CALIBRATION TECHNIQUE FOR CALIBRATING A ZIRCONIUM OXIDE OXYGEN SENSOR AND CALIBRATED SENSOR

(71) Applicant: MOCON, INC., Minneapolis, MN (US)

(72) Inventor: Michael D. Howe, Blaine, MN (US)

(73) Assignee: MOCON, INC., Minneapolis, MN (US)

(21) Appl. No.: 13/633,790

(22) Filed: Oct. 2, 2012

Related U.S. Application Data
(60) Provisional application No. 61/545,372, filed on Oct. 10, 2011.

(51) Int. Cl. G01N 37/00

(52) U.S. Cl. 73/1.06

(57) ABSTRACT

A method of calibrating a zirconium oxide sensor employing a reference gas having a known mole fraction of oxygen and a monitored gas having a known mole fraction of oxygen, characterized by use of a reference gas and a monitored gas having the same mole fraction of oxygen but different partial pressures of oxygen. This allows a single gas source, such as air, to be used for both the reference gas and the monitored gas across a range of oxygen concentration readings.

### BACKGROUND

Zirconium oxide oxygen sensors are widely used to continuously monitor the oxygen content of flue gases generated by such fuel-burning devices as boilers, kilns, ovens, internal combustion engines, driers, heat treating furnaces, incinerators, refinery process units, gas turbines, scrubbers and the like. Based on the information so gleaned, the mixture of oxygen and fuel may be adjusted to optimal levels. For example, the air being introduced into the combustion phase of a boiler may be regulated to achieve optimum efficiency, and to reduce nitrous oxide and/or sulphur dioxide emissions. Such monitoring systems can be employed to effectuate such adjustments continuously and automatically.

Zirconium oxide sensors are also employed in analytical equipment to precisely measure the oxygen content in sample gases. One such application is the PAC CHECK Benchtop O₂ Headspace Anayalzer available from Mocon, Inc. of Minneapolis, Minn.

Typically, zirconium oxide sensors consist of a ceramic tube made from zirconium oxide that has been stabilized with yttrium, with porous platinum electrodes coated opposite each other at the sensing end of the tube on the inner (monitoring) and outer (reference) surfaces of the tube. When the tube is heated to a temperature above about 600° C. (1100° F.) the ceramic material becomes permeable to oxygen ions, thus transforming the tube into an oxygen ion conducting solid electrolyte. When the number of oxygen molecules per unit volume is greater on one side of the tube relative to the other, oxygen ions migrate from the former to the latter. The platinum electrodes provide catalytic surfaces for the reduction of oxygen molecules into oxygen ions and oxidation of oxygen ions into oxygen molecules. Thus, oxygen molecules from the higher concentration side are reduced to oxygen ions at the electrode on the side of higher concentration and pass through the heated ceramic tube to the electrode on the side of lower concentration where they are oxidized back into oxygen molecules and released. This flow of ions creates an electron imbalance which produces a voltage potential between the electrodes. The magnitude of that potential is defined by the “Nernst” equation as follows:

E=(RT/zF)LnQ

Where:
E is the cell potential (electromotive force)
R is the universal gas constant (8.314 472 J K⁻¹ mol⁻¹)
T is the absolute temperature
F is the Faraday constant (9.64853399×10⁴° C.mol⁻¹)
z is the number of moles of electrons transferred in the cell reaction
Q is the reaction quotient (i.e., a function of the activities or concentrations of the chemical species involved in a chemical reaction).

The value of z for zirconium oxide sensors is 4 as the redox reaction is:

O₂ +4e⁻ [symbol] 2O⁻²

The reaction quotient (Q) for zirconium oxide sensors is the ratio of the partial pressure of oxygen in the reference gas (P1_{O2}) to the partial pressure of oxygen in the monitored gas (P2_{O2}).

Substitution of these values into the Nernst equation produces the following equation for zirconium oxide sensors:

E=(RT/4F)Ln(P1_{O2}/P2_{O2})

Hence, the concentration of oxygen in a monitored gas (P2_{O2}) can be calculated from a voltage potential reading obtained from a zirconium oxide sensor at a known absolute temperature (T) so long as the concentration of oxygen in the reference gas (P1_{O2}) is known.

Due to slight variations in the performance of each zirconium oxide sensor, and variations for a given zirconium oxide sensor over time, Calibration Factors of Gain (C_{G}) (i.e., deviation from ideal over the full output range) and Offset (C_{O}) (i.e., deviation from ideal at minimum output) are typically established for each sensor and incorporated into the Nernst equation for zirconium oxide sensors to produce the following calibrated Nernst equation for zirconium oxide sensors:

E=(RT/4F)Ln(P1_{O2}/P2_{O2})C_{G}+C_{O}

The Calibration Factors of Gain (C_{G}) and Offset (C_{O}) are typically obtained for each sensor by taking readings from the sensor employing tank gases having known partial pressures of O₂ as the monitored gas (P2_{O2}), and air (which is 20.95% oxygen by volume) as the reference gas (P2_{O1}), and adjusting the values of Gain (C_{G}) and Offset (C_{O}) as necessary to cause the calculated value for P2_{O2} obtained from each of the readings to match the known value for P2_{O2} as closely as possible.

While effective for accurately calibrating zirconium oxide sensors, this calibration method is time consuming and expensive.

Accordingly, a substantial need exists for a low cost system and method for quickly, accurately and reliably calibrating zirconium oxide sensors.

### SUMMARY OF THE INVENTION

A first aspect of the invention is a method of calibrating a zirconium oxide oxygen sensor. The calibration method employs a reference gas having a known mole fraction of oxygen and a monitored gas having a known mole fraction of oxygen, and is characterized by use of a reference gas and a monitored gas having the same mole fraction of oxygen but different partial pressures of oxygen.

In further detail, one embodiment of the first aspect of the invention involves the steps of (i) placing the first surface of the ZrO₂ sensor in fluid communication with a reference gas having a known non-zero concentration of oxygen at a known total first pressure, (ii) placing the second surface of the ZrO₂ sensor in fluid communication with the reference gas at a known total second pressure which is different than the known total first pressure to form a ΔP1 subjected zirconium oxide sensor, (iii) calculating an expected oxygen content reading from the ΔP1 subjected zirconium oxide sensor employing a calibrated Nernst equation for zirconium oxide sensors, (iv) taking an oxygen content reading with the ΔP1 subjected zirconium oxide sensor, (v) correlating the oxygen content reading taken with the ΔP1 subjected zirconium oxide sensor with the expected oxygen content reading for the ΔP1 subjected zirconium oxide sensor to create a correlated pair of ΔP1 values, and (vi) calibrating the zirconium oxide sensor employing the correlated pair of ΔP1 values.

A second aspect of the invention is a zirconium oxide oxygen sensor calibrated in accordance with the first aspect of the invention.

### DETAILED DESCRIPTION OF A PREFERRED EMBODIMENT

### Definitions

As used herein, including the claims, the “Calibrated Nernst equation for zirconium oxide sensors” means:

E=(RT/4F)Ln(P1_{O2}/P2_{O2})C_{G}+C_{O}

Where:
E is the cell potential (electromotive force)
R is the universal gas constant (8.314 472 J K⁻¹ mol⁻¹)
T is the absolute temperature
F is the Faraday constant (9.64853399×10⁴° C. mol⁻¹)
z is the number of moles of electrons transferred in the cell reaction (4)
P1_{O2} is the partial pressure of oxygen in the reference gas
P2_{O2} is the partial pressure of oxygen in the monitored gas
C_{G} is the Gain Calibration Factor
C_{O} is the Offset Calibration Factor.

and wherein at least one of the Calibration Factors of Gain (C_{G}) and Offset (C_{O}) are employed.

### Calibration Method

A reference gas having a known mole fraction of oxygen is selected. A preferred reference gas is air due to its ready availability and reliable static concentration of oxygen (i.e., 20.86% assuming an RH of 50%). Tank gases containing a known non-zero concentration of oxygen may also be used as the reference gas.

A monitored gas having the same mole fraction of oxygen as the reference gas is selected. The monitored gas is preferably the same as the reference gas, and most preferrably obtained from the exact same source as the reference gas (e.g., the immediately surrounding atmosphere).

The reference gas is placed into fluid communication with the exterior surface of the heated ZrO₂ ceramic tube at a known pressure, from which the partial pressure of oxygen in the reference gas P1_{O2} can be calculated employing Dalton's Law of Partial Pressures since the mole fraction of oxygen in the reference gas is known. A preferred pressure for the reference gas is the current atmospheric pressure at the testing site.

The monitored gas is placed into fluid communication with the interior surface of the heated ZrO₂ ceramic tube at a known pressure which is different from the pressure of the reference gas in fluid communication with the exterior surface of the heated ZrO₂ ceramic tube. This can most conveniently be attained by introducing reference gas into the interior chamber of the ZrO₂ ceramic tube, sealing off the interior chamber, and then pulling a vacuum until the desired reduced pressure is attained. As with the reference gas, knowledge of the oxygen mole fraction and the total pressure of the monitored gas within the interior chamber of the ZrO₂ ceramic tube allows the partial pressure of oxygen in the monitored gas P2_{O2} to be calculated employing Dalton's Law of Partial Pressures.

Readings are taken with the sensor at several different monitored gas pressures, with a corresponding calculated value for E, or alternatively converted to O₂ concentration, made using the Calibrated Nernst equation for zirconium oxide sensors for each reading, thereby creating a paired array of sensed and calculated values. Readings are preferably taken over a wide range of monitored gas pressures, with at least one and preferably a plurality of readings taken at a monitored gas pressure that is less than 50% of the reference gas pressure, most preferably less than 25% of the reference gas pressure and most preferably between 5% and 20% of the reference gas pressure.

The paired array of sensed and calculated values allow the Calibration Factors of Gain (C_{G}) and/or Offset (C_{O}) to be ascertained for the sensor employing standard calibration techniques well know to those of routine skill in the art.

I claim:

1. A method of calibrating a zirconium oxide sensor employing a reference gas having a known mole fraction of oxygen and a monitored gas having a known mole fraction of oxygen, characterized by use of a reference gas and a monitored gas having the same mole fraction of oxygen but different partial pressures of oxygen.

2. The method of claim 1 wherein the reference gas and the monitored gas are obtained from the same source, with the difference in oxygen partial pressure resulting from a difference in total pressure.

3. A method of calibrating a zirconium oxide sensor, comprising the steps of:
(a) obtaining a zirconium oxide sensor operable for measuring oxygen content of a monitored gas by detecting passage of oxygen ions through a heated zirconium oxide ceramic partition having opposed first and second surfaces with the first surface in fluid communication with a reference gas having a known partial pressure of oxygen and the second surface in fluid communication with the monitored gas,
(b) obtaining a first calibration value by (i) placing the first surface in fluid communication with a reference gas having a known non-zero concentration of oxygen at a known total first pressure, (ii) placing the second surface in fluid communication with the reference gas at a known total second pressure which is different than the known total first pressure to form a ΔP1 subjected zirconium oxide sensor, and (iii) calculating an expected oxygen content reading from the ΔP1 subjected zirconium oxide sensor employing a calibrated Nernst equation for zirconium oxide sensors,
(c) taking an oxygen content reading with the ΔP1 subjected zirconium oxide sensor,
(d) correlating the oxygen content reading taken with the ΔP1 subjected zirconium oxide sensor with the expected oxygen content reading for the ΔP1 subjected zirconium oxide sensor to create a correlated pair of ΔP1 values, and
(e) calibrating the zirconium oxide sensor employing the correlated pair of ΔP1 values.

4. The method of claim 2 further comprising the steps of:
(f) obtaining a second calibration value by (i) placing the first surface in fluid communication with the reference gas at a known total first pressure, (ii) placing the second surface in fluid communication with the reference gas at a known total third pressure which is different than both the known total first and second pressures to form a ΔP2 subjected zirconium oxide sensor, and (iii) calculating an expected oxygen content reading from the ΔP2 subjected zirconium oxide sensor employing the calibrated Nernst equation for zirconium oxide sensors,
(g) taking an oxygen content reading with the ΔP2 subjected zirconium oxide sensor,
(h) correlating the oxygen content reading taken with the ΔP2 subjected zirconium oxide sensor with the expected oxygen content reading for the ΔP2 subjected zirconium oxide sensor to create a correlated pair of ΔP2 values, and
(i) employing the correlated pair of ΔP2 values along with the correlated pair of ΔP1 values to calibrate the zirconium oxide sensor.

5. The method of claim 2 wherein the reference gas is air.

6. The method of claim 3 wherein the reference gas is air.

7. The method of claim 4 wherein the reference gas is air.

8. The method of claim 1 wherein the reference gas is employed at atmospheric pressure.

9. The method of claim 3 wherein the known total first pressure is atmospheric pressure.

10. The method of claim 4 wherein the known total first pressure is atmospheric pressure.

11. The method of claim 1 wherein the monitored gas is employed at a total pressure of less than 20% of the total pressure at which the reference gas is employed.

12. The method of claim 3 wherein the known total second pressure is less than 20% of the known total first pressure.

13. The method of claim 4 wherein the known total second pressure is less than 20% of the known total first pressure.

14. The method of claim 13 wherein the known total third pressure is more than twice the known total second pressure.

15. An oxygen sensor comprising a zirconium oxide sensor calibrated in accordance with the method of claim 1.

16. An oxygen sensor comprising a zirconium oxide sensor calibrated in accordance with the method of claim 2.

17. An oxygen sensor comprising a zirconium oxide sensor calibrated in accordance with the method of claim 3.

18. An oxygen sensor comprising a zirconium oxide sensor calibrated in accordance with the method of claim 4.

19. An oxygen sensor comprising a zirconium oxide sensor calibrated in accordance with the method of claim 5.

20. An oxygen sensor comprising a zirconium oxide sensor calibrated in accordance with the method of claim 6.

21. An oxygen sensor comprising a zirconium oxide sensor calibrated in accordance with the method of claim 7.
